(19) United States
(12) Patent Application Publication
(10) Pub. No.: US 2010/0161451 A1
(43) Pub. Date: Jun. 24, 2010

(54) EFFICIENT COMPUTATION OF AVAILABLE TO PROMISE (ATP) IN SUPPLY CHAINS

(75) Inventors: Narayan Venkatasubramanyan, Coppell, TX (US); Srinivasan Kumar, Sunnyvale, CA (US); Amarinder P. Singh, Burlingame, CA (US)

Correspondence Address: FSP LLC, P.O. BOX 890, VANCOUVER, WA, 98666, US

(73) Assignee: Amitive, San Mateo, CA (US)

(21) Appl. No.: 12/339,436

(22) Filed: Dec. 19, 2008

(51) Int. Cl. G06Q 10/00

(52) U.S. Cl. 705/28

(57) ABSTRACT

An inventory supply management procedure involves representing inventory supply events in a data processing device memory with indications of times at which the supply events take place, and associating with each supply event at least an Available to Promise (ATP) and an ATP Restoration Guide (ATPRG) value.

### TECHNICAL FIELD

The present disclosure relates to supply chain management.

### BACKGROUND

Traditionally, the tactical planning of a supply chain has been divided into two parts. These two parts are “planning” and “promising”. Planning is a periodic activity, which results in the creation of a plan that is feasible with respect to constraints known at planning time. Promising is a continuous activity which is triggered by the arrival or cancellation of requests for inventory.

A plan for an item at a facility comprises expected inflows and outflows. An inflow specifies inventory in terms of (1) the quantity, and (2) the time of arrival. An outflow specifies inventory in terms of (1) the quantity, and (2) the time of departure. Upon creation of a plan, the net availability of inventory (also called “Available to Promise”, or ATP) at particular points in time serves as the basis for ‘promising’. Promising is the commitment of available inventory to new orders. ATP comprises a set of time-quantity pairs in chronological order.

Prior art promising procedures proceed as follows. First, an order is received for a certain quantity of inventory to be provided at a certain time (e.g. an order for a particular quantity of a particular item at a particular storage facility). The inventory allocation process starts at the time when the order is due to be provided. The allocation process proceeds backward in time, picking up some or all of the inventory available to meet the order and committing it to that order, until (1) either the requested quantity of inventory has been found and committed to meet the order, or (2) all available inventory prior to the due date of the order has been committed. If (2), the order cannot be fulfilled on time. Yet it still may be possible to fulfill the order in full at a date later than the due date. The allocation process thus proceeds forward in time, starting at the order due date, and commits some or all of the available inventory, until (1) either the requested quantity has been found and committed, or (2) all available inventory has been committed. If the latter, the order cannot be fulfilled completely.

Another event to consider in managing inventory is order cancellations. Cancellations may occur in different forms. A customer may cancel an order that had been promised for a specific quantity at a specific time. Alternatively, a quote on a potential order may expire, and this will be treated as if an order were canceled. Upon occurrence of a cancellation the available inventory needs to be restored. In this way future promises may be made against the released inventory.

Traditionally, there have been different approaches to handling order cancellation. According to conventional thinking, the computational effort required to restore available inventory “optimally” is too expensive to be implemented in a real-time engine. Therefore, traditional inventory restoration algorithms have been heuristic and hence sub-optimal. The most commonly used approach to inventory restoration is to maintain a pegging relationship that effectively reserves specific supplies to specific demands. FIG. 1 illustrates some problems with this approach.

FIG. 1-A shows the state of the inventory allocation process immediately after a planning cycle. Particular quantities of inventory arrive at particular times (10 units, then 5 units, then another 10 units). FIG. 1-B shows the situation when a new order for 17 units of inventory is received at a particular time. Under the conventional approach, the 17 units are satisfied by proceeding backwards in time, and picking 10 units, then 5 units and then 2 units from the three supplies. In addition, these quantities are pegged to the promise to facilitate inventory restoration in the event of a later cancellation.

FIG. 2-A shows the arrival of an order for 5 units. Inventory to satisfy this order is committed from the 8 units still available to commit from the original inventory of 10 units. Now, consider what may happen upon the cancellation of the first order. The 17 committed inventory items are released and are made available again. Conventionally, the restoration of the inventory is accomplished by simply discarding the peggings between the cancelled order and units of inventory committed at certain times. This process is illustrated in FIG. 2-B. Two units of inventory are restored to the first batch of 10 items, 5 are restored to the second batch, and 10 are restored to the third batch. Five units from the first batch remain committed to the second order.

FIG. 3-A shows a state that would be optimal after the events illustrated in FIGS. 1 and 2 have transpired. All of the inventory committed to the second order is committed from the second inventory lot. FIG. 3-B shows the impact of a third order for 8 units on the state of the system after a conventional restoration of the cancelled first order. Five units from the first inventory batch remain committed to the second order. The remaining uncommitted 5 units of the first inventory batch are committed to meet the third order. Also committed are 3 units from the second inventory batch. The order for 8 units is not fulfilled on time and must be delayed until arrival of the second inventory batch where the final 3 units to meet the order are found.

Thus, an approach is needed to inventory management and order cancellation that results in more optimal allocations.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1-A shows the state of an inventory allocation process immediately after a planning cycle.

FIG. 1-B shows the situation for FIG. 1-A when a new order for 17 units of inventory is received at a particular time.

FIG. 2-A shows the arrival of an order for 5 units in the system of FIGS. 1A and B.

FIG. 2-B shows the conventional process of restoration of the cancelled inventory accomplished by simply discarding the peggings between the cancelled order and units of inventory committed at certain times.

FIG. 3-A shows a state that would be optimal after the events illustrated in FIGS. 1 and 2 have transpired.

FIG. 3-B shows the impact of a third order for 8 units on the state of the system after a conventional restoration of the cancelled first order.

FIG. 3-C shows the impact of the third order for 8 units on the state of the system after the restoration of the inventory following the cancellation of the first order using a more optimal process dealing with promising and cancellation of orders

FIGS. 4 and 5 are flow charts of an embodiment of a process of updating supply events represented in a machine memory, upon receipt of an order.

FIG. 6 is a flow chart of an embodiment of a process of restoring inventory upon cancellation of an order.

FIG. 7 is a block diagram illustration of a machine memory organization of an inventory plan.

FIG. 8 is a block diagram of a data processing device having a memory organization and logic in accordance with the procedures described herein.

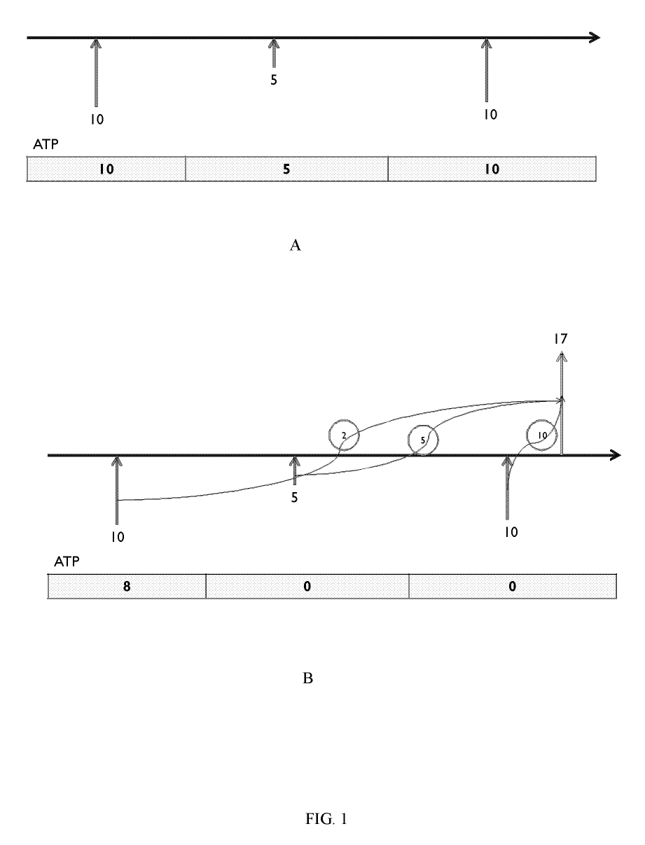

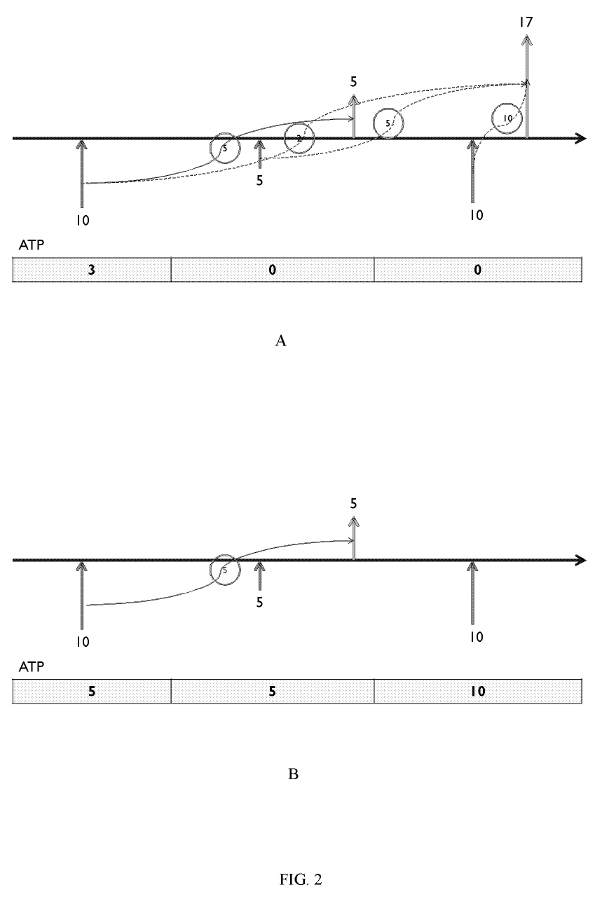

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Those skilled in the art will appreciate that logic may be distributed throughout one or more devices, and/or may be comprised of combinations of instructions in memory, processing capability, circuits, and so on. Therefore, in the interest of clarity and correctness logic may not always be distinctly illustrated in drawings of devices and systems, although it is inherently present therein.

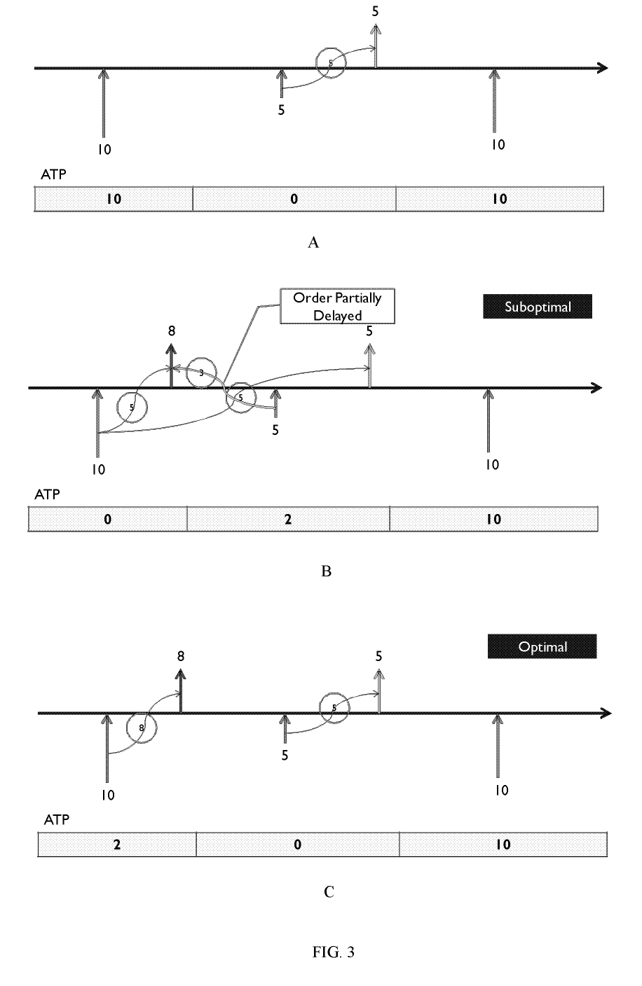

FIG. 3-C shows the impact of the third order for 8 units on the state of the system after the restoration of the inventory following the cancellation of the first order using a unique process dealing with promising and cancellation of orders. Ten units of inventory remain uncommitted in the first inventory batch, and 8 of these units are committed to meet the order on time. Five units from the second inventory batch remain committed to the second order, which is also met on time.

In order to provide an improved allocation of inventory during orders and cancellations, a computer system may implement logic to carry out an inventory planning cycle. Inputs to this planning logic may include expected inventory supply dates and inventory amounts expected to arrive on those dates. The plan may be stored efficiently in a computer memory and may include, for example, data pairs of the form (supply, time) where supply represents the amount of inventory expected to arrive and time is the date and/or time the inventory is expected to arrive.

After the plan is established and as orders arrive and inventory is committed to meet those orders, certain values may be maintained to facilitate efficient planning. These values may include, for each data pair described above, (1) incremental ATP, (2) incremental NATP, and (3) ATPRG.

Incremental ATP represents the change in the amount of inventory that is available to promise at a particular time. Incremental NATP (Not ATP) is then defined to be the inventory supply expected to arrive at a particular time, minus the incremental ATP, i.e. the inventory that has already been committed to requests received earlier. An ATP Restoration Guide (ATPRG) value for a particular time is then defined (see below), and upon cancellation of an order the ATPRG values are applied to restore the correct amount of committed inventory to available status at each data pair in the plan. The values of ATP, NATP and ATPRG at various points in the plan may be updated upon cancelation of an order.

In order to facilitate description of the inventory allocation logic, we introduce certain notations. These notations may represent values in the memory of a computing system implementing the planning logic, although not all implementations may include each and every one. The concept of time is represented as a value t, where the precision of t is left open to the implementation, e.g. a date, or a date/time value.

supply [0]=initial inventory supply at the start of the planning cycle (t=0)

supply [t]=inventory supply expected to arrive at time t

committed_to_orders [t]=inventory committed to orders at time t

By convention, if inventory is committed at the same time inventory is expected to arrive, the inventory is treated as committed immediately after arrival of the expected inventory. In other words, for a given time t, the inventory at that time available to be committed will always include any inventory that is expected to arrive at that time.

c_supply [t]=Cumulative inventory supply up to and including time=t

c_committed_to_orders [t]=Cumulative committed inventory up to and including time=t

c_uncommitted_to orders [t]=Cumulative uncommitted inventory up to and including time=t

The cumulative uncommitted supply up to a time t is the difference between the cumulative supply up that time and the cumulative committed supply up to that time.

c_uncommitted_to orders[t]=c_supply[t]−c_committed_to_orders[t]

When an allocation plan is first created, the plan is assumed to be feasible. Thus, the cumulative uncommitted inventory is guaranteed to be non-negative for all values of t. The cumulative amount of inventory that is available to commit to orders (i.e. the cumulative ATP) at any time t is set to be the minimum uncommitted inventory at that time t and beyond.

c_atp[t]=min(c_uncommitted_to_orders[τ]: t≦τ)

By the nature of the definition, we are guaranteed that c_atp[t]≦c_uncommitted_to_orders[t] for all t.

The c_atp values are a series of upward steps at the times at which supply[t] has non-zero values. Incremental ATP is defined as the increase in c_atp at time=t, e.g. c_atp[t]=c_{—atp[t-}1]. By the nature of the definition, we are guaranteed that atp[t]≦supply[t] for all t.

We define complementary functions cumulative NATP (cumulative Not Available to Promise) and incremental NATP as follows:

c_natp [t]=c_supply [t]−c_atp [t]

natp[t]=supply [t]−atp[t]

Finally, we define the ATP restoration guide function (ATPRG) as follows: ATPRG[t]=c_natp[t]−c_committed_to_orders[t]. By the nature of the definition, it is guaranteed that ATPRG[t]≦0 for all t.

The logic to allocate inventory upon occurrence of an order may be stated as follows.

Define ordered set supply_events as supply_events={i: supply (i)>0}

Define ordered set order_events as order_events={i: order (i)>0}

Define ordered set events as events=supply_events UNION order_events

k is the time of a new order

Define pair-set X where each element of X is a {inventory_quantity, time} pair. Initially, X is empty.

Committing Inventory to an Order

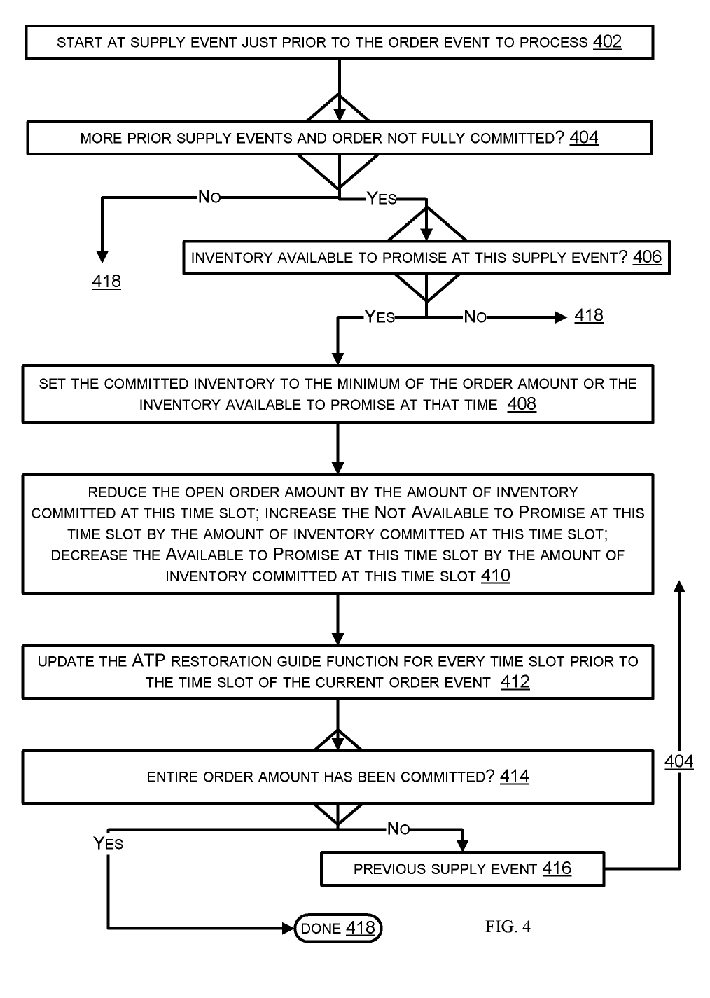

The process embodiment below is also illustrated in FIG. 4. Notice the relatively straightforward processing and updates at each supply event. The process provides for a superior inventory cancellation technique, and it is suitable for real-time or near-real-time execution by an appropriately configured computer system.

1 (FIG. 4 at 402). Set j=the time of the latest supply event prior to the order event to process (order at time k)

j←max{i:i≦k} i ε supply_events

2 (FIG. 4 at 404). Process an order event at time k

WHILE j≠# NULL AND order [k]>0

3 (FIG. 4 at 406). If there is inventory available to promise at this time . . .

IF atp[j]>0 THEN

4 (FIG. 4 at 408). Set the committed inventory to the minimum of the order amount

or the inventory available to promise at that time

committed [j]←min (order [k],atp [j])

INSERT INTO X {committed [j], j}

5 (FIG. 4 at 410). Reduce the open order amount by the amount of inventory

committed at this time slot

order [k]←order [k]−committed [j]

6 (FIG. 4 at 410). Increase the Not Available to Promise at this time slot by the

amount of inventory committed at this time slot

natp[j]←natp[j]+committed [j]

7 (FIG. 4 at 410). Decrease the Available to Promise at this time slot by the amount

of inventory committed at this time slot

atp[j]←atp[j]−committed [j]

8 (FIG. 4 at 412). Update the ATP restoration guide function for every time slot prior

to the time slot of the current order event. PRED means predecessor in the set.

FOR n←j TO PRED(events, k) ATPRG[n]←ATPRG[n]+committed [j]

9 (FIG. 4 at 414). If the entire order amount has been committed, the allocation of inventory

to the order is complete

IF order [k]=0 RETURN X

10 (FIG. 4 at 416). Otherwise continue committing inventory for the order from previous

supply events

ELSE j←PRED (supply_events, j)

If the order is not fully satisfied after the processing above, it means that the order could not be filled from available inventory at and prior to the order date. Thus, the process continues to commit available inventory to the order beginning with the date after the order date.

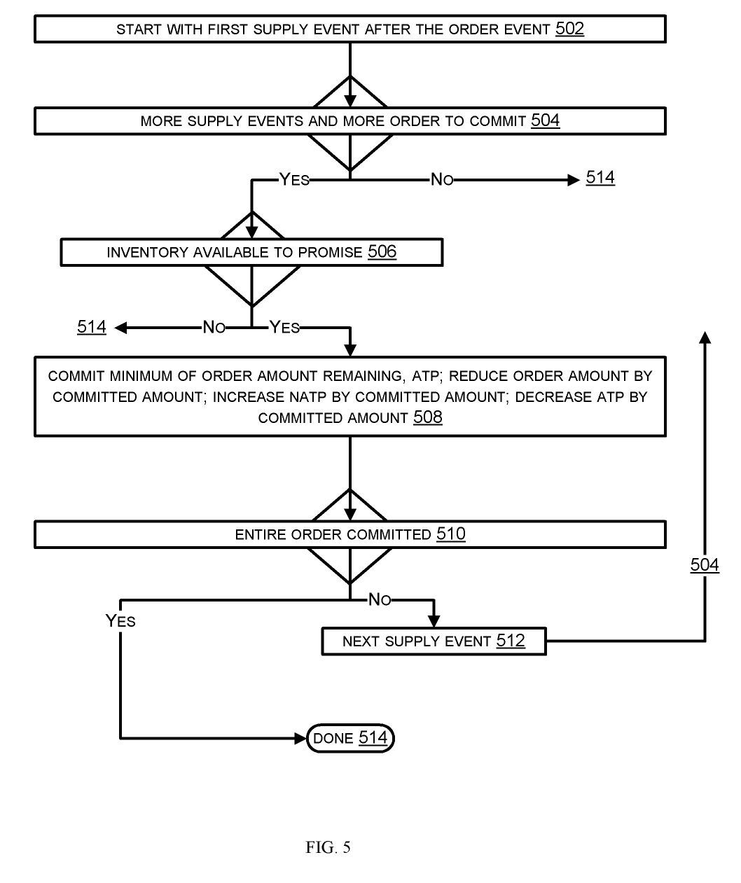

The process embodiment below is also illustrated in FIG. 5.

11 (FIG. 5 at 502). Set j=the time of the first supply event after the order event to process (order at time k)

j←min{i:i>k} i ε supply_events

12 (FIG. 5 at 504). Continue to commit available inventory to the order

WHILE j≠NULL AND order [k]>0

13 (FIG. 5 at 506). If there is inventory available to promise at this time . . .

IF atp[j]>0 THEN

14 (FIG. 5 at 508). Set the committed inventory to the minimum of the order amount

of the inventory available to promise at that time

committed [j]←min (order [k], atp [j])

INSERT INTO X {committed [j], j}

15 (FIG. 5 at 508). Reduce the open order amount by the amount of inventory

committed at this time slot

order [k]←order [k]−committed [j]

16 (FIG. 5 at 508). Increase the Not Available to Promise at this time slot by the

amount of inventory committed at this time slot

natp[j]←natp[j]+committed [j]

17 (FIG. 5 at 508). Decrease the Available to Promise at this time slot by the amount

of inventory committed at this time slot

atp[j]←atp[j]−committed [j]

Note that there is no ATPRG update here

18 (FIG. 5 at 510). If the entire order amount has been committed, the allocation of

inventory to the order is complete

IF order [k]=0 RETURN X

19 (FIG. 5 at 512). Otherwise continue committing inventory to the order from subsequent

supply events. SUCC means successor in the set.

ELSE j←SUCC (supply_events, j)

If we reach this point and there remains inventory to commit to the order, it means the order cannot be fulfilled from available supply.

Releasing Inventory for a Cancelled Order

Unlike prior approaches, orders are not pegged to specific supply events. Instead, the ATP restoration guide is traversed to release committed inventory in a more optimal fashion. Updates at the supply events are relatively straightforward. The process not only results in superior inventory allocations after cancellations, but is also suitable for real-time or near-real-time execution by an appropriately configured computer system.

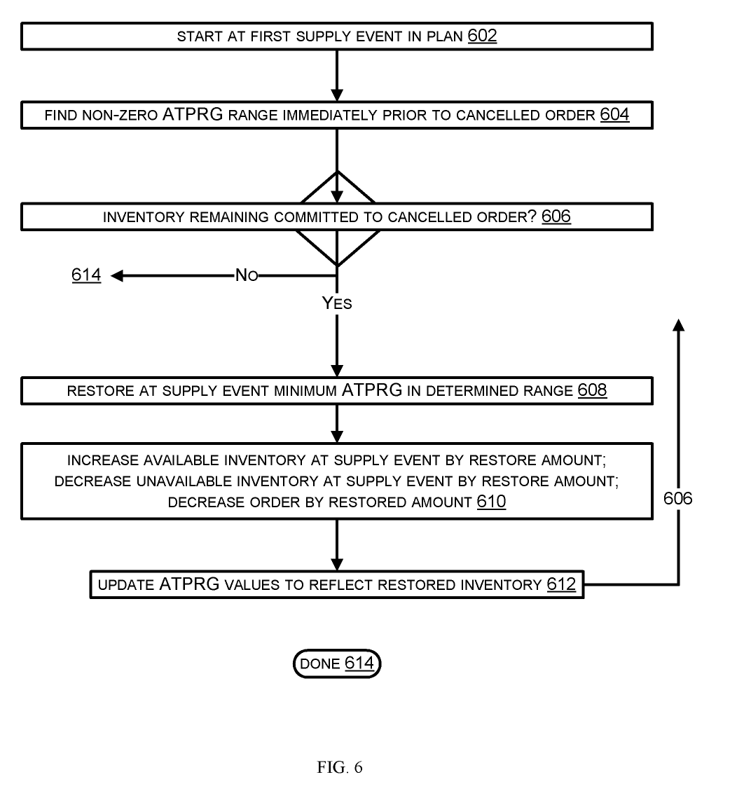

The process embodiment below is also illustrated in FIG. 6.

k is the time of an order cancellation

The set X that was constructed during order promising is also used in order cancellation. For example, if an order for 10 units is due at t=7, and of that order 6 units were promised on time (on or before t=7) and the rest was promised at t=9, then X would be {(6,7), (4,9)}. In some embodiments, if this order is cancelled, the commitment at t=6 may be cancelled, then the commitment at t=9 may be cancelled.

1 (FIG. 6 at 602). Start with the first supply event in the inventory plan and move forward in time

current_supply_event←FIRST (supply_events)

2 (FIG. 6 at 604). Find the range of nonzero ATPRG immediately prior to the cancelled order

WHILE min {ATPRG[i]: i ε events AND i≧current_supply_event AND i<k}=0

current_supply_event←SUCC (supply_events, current_supply_event)

3 (FIG. 6 at 606). While there's remaining inventory committed to the cancelled order . . .

WHILE order_commitment [k]>0

4 (FIG. 6 at 608). The amount to restore at a particular supply event is the minimum ATPRG

value between that supply event (inclusive) and the order

restore_amount←min {ATPRG[i]: i ε events AND i≧current_supply_event AND i<k}

5 (FIG. 6 at 610). Increase available inventory at this supply event

atp[current_supply_event]←atp[current_supply_event]+restore_amount

6 (FIG. 6 at 610). Decrease unavailable inventory at this supply event

natp[current_supply_event]←natp[current_supply_event]−restore_amount

7 (FIG. 6 at 610). Release the restored quantity from the cancelled order

order_commitment [k]←order_commitment[k]−restore_amount

8 (FIG. 6 at 612). Now update the ATPRG values to reflect the released inventory

FOREACH i in events where i≧current_supply_event AND i<k

ATPRG[i]←ATPRG[i]−restore_amount

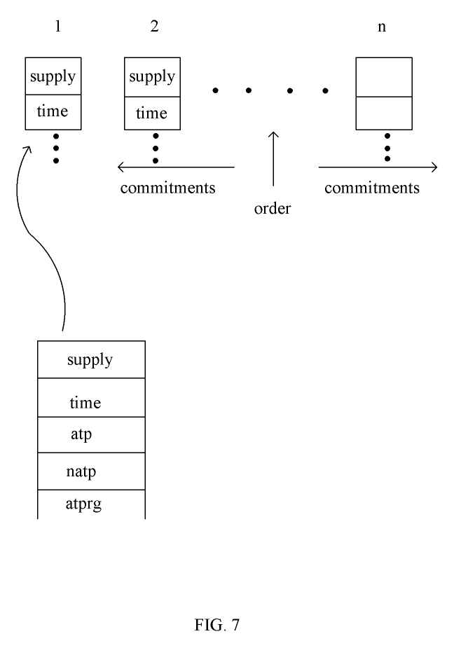

FIG. 7 is a block diagram illustration of an exemplary machine memory organization in support of procedures described herein. Information may be associated with each supply event, for example via a data structure. The associated information may include the amount of the supply (“supply”), the time of the supply event (“time”), the available to promise (“atp”), the not available to promise (“natp”), and the ATPRG restoration guide amount for the supply event. The supply events may be organized in the memory using various techniques, such as one or more arrays, linked lists, stacks, data structures, and so on. The organization of supply events may be ordered in time, so that when orders are received with a delivery date, the supply may be committed first from events preceding the delivery date, then, if necessary, from supply events post-dating the delivery date (meaning the delivery will be late).

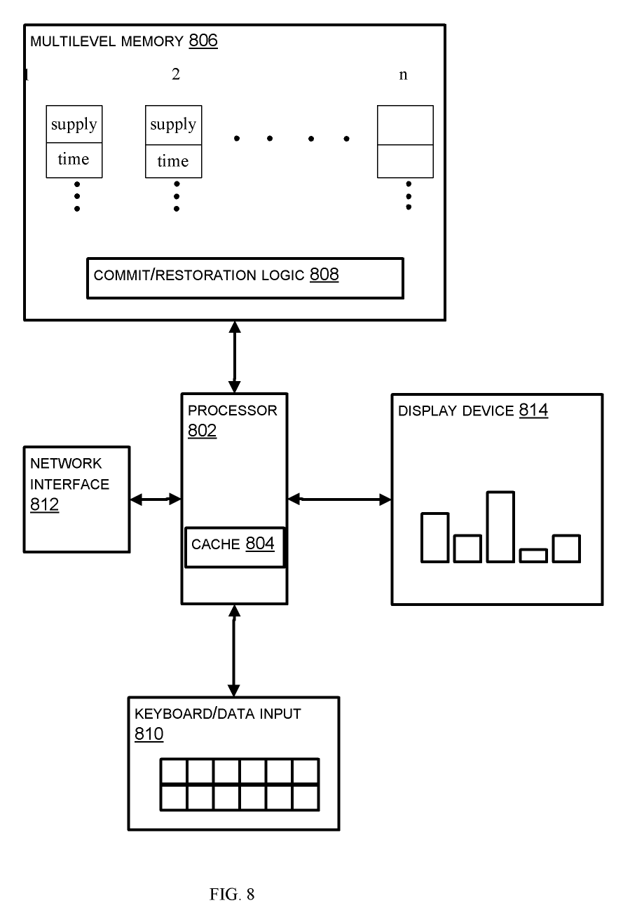

FIG. 8 is a block diagram of an exemplary data processing device to carry out techniques for inventory management as described herein. The device may comprise a multi-level memory system 806, comprising one or more of various memory technologies (e.g. one or more of hard disk, optical disk, tape, Random Access Memory, flash memory, SRAM, etc). Data structures representing supply events may be stored and represented in the multi-level memory system 806. The multi-level memory system 806 may further comprise inventory commitment and restoration logic 808, for example to represent procedures as described in conjunction with FIGS. 4-6. The multi-level memory system 806 may be coupled to a processor 802 (which may include a cache 804) which may execute instructions of the logic 808, to operate upon and update the data structures that organize the memory 806. A network interface 812 may provide data communication with other processing devices, and may provide for communication of inventory events and order events into the data processing device, and may likewise provide to communicate information of the data structure of the memory 806 (e.g. ATP for a particular supply event, etc) to other data processing devices. A keyboard 810 or other data input device, or combination thereof, may provide for data entry into the memory 806, such as the entry of supply and order events, and other information of the inventory plan. A display device 814 may provide for visual output of information represented by the structure of the memory 806, such as graphical indications of the status of committed and uncommitted inventory, supply events, orders, and so on.

Note that the procedures described herein, and the manners of representing an inventory plan for order commitment and release, and the manners of representing those procedures in a data processing device, are merely some of the possible manners of such organization and procedures. For example, those skilled in the art will recognize that other manners of organizing the inventory plan in a multi-level memory are feasible. Furthermore, other manners of operating on the inventory plan memory organization to achieve order commitment and release are also feasible.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optimal aspects of implementations may involve optimally-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. An inventory supply management procedure comprising:
representing inventory supply events in a data processing device memory with indications of times at which the supply events take place; and
associating with each supply event at least an Available to Promise (ATP) and an ATP Restoration Guide (ATPRG) value.

2. The inventory supply management procedure of claim 1, further comprising:
updating ATP and ATPRG values backward in time from an order due date according to committed inventory amounts.

3. The inventory supply management procedure of claim 1, further comprising:
if insufficient inventory is available to promise at times before an order due date, updating ATP but not ATPRG values forward in time from the order delivery date according to committed inventory amounts.

4. The inventory supply management procedure of claim 1, further comprising:
associating with each supply event a Not Available to Promise (NATP) value.

5. The inventory supply management procedure of claim 1, further comprising:
updating NATP values backward in time from an order due date according to committed inventory amounts.

6. The inventory supply management procedure of claim 1, further comprising:
updating NATP values forward in time from an order due date according to committed inventory amounts.

7. The inventory supply management procedure of claim 1, further comprising:
in the memory representation of inventory supply events, identifying a range of nonzero ATPRG values immediately prior to a time of a cancelled order; and
while there is remaining inventory committed to a cancelled order, determining an amount of inventory to restore to available status at a particular supply event based upon a minimum ATPRG value between the particular supply event and the order committed date.

8. The inventory supply management procedure of claim 1, further comprising:
updating ATPRG values between the order committed date and the particular supply event according to the amount of inventory restored at the particular supply event.

9. A memory for a data processing device, the memory comprising logic that when applied to one or more processors of the data processing device, result in representing inventory supply events in the data processing device memory with indications of times at which the supply events take place; and associating with each supply event at least an Available to Promise (ATP) and an ATP Restoration Guide (ATPRG) value.

10. The memory of claim 9, further comprising logic that when applied to one or more processors of the data processing device, results in updating ATP and ATPRG values backward in time from an order due date according to committed inventory amounts.

11. The memory of claim 9, further comprising logic that when applied to one or more processors of the data processing device, results in: if insufficient inventory is available to promise at times before an order delivery date, updating ATP but not ATPRG values forward in time from the order due date according to committed inventory amounts.

12. The memory of claim 9, further comprising logic that when applied to one or more processors of the data processing device, results in associating with each supply event a Not Available to Promise (NATP) value.

13. The memory of claim 9, further comprising logic that when applied to one or more processors of the data processing device, results in updating NATP values backward in time from an order due date according to committed inventory amounts.

14. The memory of claim 9, further comprising logic that when applied to one or more processors of the data processing device, results in updating NATP values forward in time from an order due date according to committed inventory amounts.

15. The memory of claim 9, further comprising logic that when applied to one or more processors of the data processing device, results in: in the memory representation of inventory supply events, identifying a range of nonzero ATPRG values immediately prior to a time of a cancelled order; and while there is remaining inventory committed to a cancelled order, determining an amount of inventory to restore to available status at a particular supply event based upon a minimum ATPRG value between the particular supply event and the order committed date.

16. The memory of claim 9, further comprising logic that when applied to one or more processors of the data processing device, results in updating ATPRG values between the order committed date and the particular supply event according to the amount of inventory restored at the particular supply event.
